(19) United States
(12) Patent Application Publication
(10) Pub. No.: US 2007/0157160 A1
(43) Pub. Date: Jul. 5, 2007

(54) Auto-zoomable snippets in multiple snippet windows

(76) Inventors: Udo Arend, Heidelberg (DE); Martin Hensel, Hartmannsdorf (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/320,690

(22) Filed: Dec. 30, 2005

(51) Int. Cl. G06F 9/44

(52) U.S. Cl. 717/105; 717/113

(57) ABSTRACT

Multiple information snippets are simultaneously presented in a computer screen. Auto-zooming of a snippet may be provided to enable the user to quickly obtain additional information associated with a selected snippet. Concurrent with the automatic zooming of one of the snippets on a screen, attributes including size, location, context, etc. of the other snippets on the screen may be adjusted to maintain a reasonable relationship with the zoomed snippet. The size and other display characteristics of the snippets on the screen may be automatically determined and adjusted so that the content of each snippet, and the relationship among all the snippets in the screen, may be presented to the user in a reasonable and logical manner.

### TECHNICAL FIELD

The field of the invention relates in general to computer systems and graphic user interface environments. More particularly, the field of the invention relates to presentation and manipulation of multiple auto-zoomable snippets in a computer display screen.

### BACKGROUND

It is common in today's computing environment to present information to a user in graphic user interfaces (GUIs). A well known type of GUI is a window. A window typically includes, for example, a display region, a number of user interface controls, such as scroll bars, resize controls, toolbars, etc., and any other suitable display and/or interactive elements.

Often, an application running on a computer may use one or more windows to display information. It has also become feasible for a user to simultaneously execute more than one application program on a computer, resulting in multiple windows being displayed on the computer screen. At present, due to limited screen space, when multiple windows are simultaneously displayed, the windows are arranged, for example, in layers, so that some of the windows are obstructed. Usually, the window layers are arranged according to a hierarchy in which the primary or most current window is displayed in the foreground, while other windows are sent to the background. When confronted with such a layered arrangement, a user who desires to interact with a background window, must first bring the window to the foreground, for example, by selecting the window from a toolbar. In doing so, the user causes windows currently displayed in the foreground to be sent to the background.

This layered window arrangement has a number of drawbacks. For example, a user working in a first window may not easily view or interact with information in a second window, at least not without either manually bringing the second window to the foreground or resizing/rearranging the first and second windows so the desired information in both windows remain visible on the screen when one of the windows is displayed in the foreground. This type of manual exercise is not only frustrating and time consuming, it may not even achieve the intended result. For example, resizing may cause the content of one or more windows to become obscured. In some instances, the total display space of a screen may be such that overlapping of windows cannot be avoided even with manual repositioning and resizing.

More problems may arise if the user wishes not only to display multiple windows but to actually interact with multiple windows simultaneously. As an example, the user may wish to paste information copied from one window into another. In a layered window arrangement, because only one window is active in the foreground, the user must sequentially bring different windows to the foreground to achieve the copying and pasting.

In view of the above, a need exists for an improved way of presenting multiple windows or other suitable information displays on a screen so information in the windows or displays may be simultaneously presented in a useful manner and so user manipulation of these windows or displays may be convenient and intuitive.

### SUMMARY

Consistent with the principles of the present invention, a method and system simultaneously presents multiple information snippets in a graphic user interface, hereinafter referred to generally as a screen. An information snippet may be any suitable display of information. In some systems consistent with the principles of the present invention, the information snippets may allow user interactivity. In some systems consistent with the principles of the present invention, when multiple information snippets are simultaneously displayed, the information snippets may contain related information and may be suitably arranged to provide a user with a logical display context.

In some systems, the size of the snippets on the screen may be automatically determined and adjusted so that the content of each snippet, and the relationship among all the snippets in the screen, may be presented to the user in a reasonable and logical manner. During the adjustment process, various aspects of a snippet including, the layout, the content, the relationship, etc., may be considered and adjusted. As an example, the relationship between a snippet containing a datasheet and a snippet containing a graphic representation of that datasheet may be considered, and the snippets may be presented side-by-side on the screen as a result of that consideration. In order to accommodate the side-by-side arrangement on the screen, the font of the data in the datasheet snippet may be reduced to a smaller, but still readable size, which may be automatically determined. In addition, reduction may be made to the amount of data currently shown in the datasheet snippet. Similarly adjustments may be made to the size as well as the graphic details shown in the graphics snippet. Regardless of the adjustments made, information displayed in each of the snippets may be displayed in a coherent manner. The coordinated and combined adjustments to the datasheet snippet and the graphics snippet together achieve the logical display of the two snippets in the side-by-side arrangement.

Due to screen size limitations, a snippet in a screen often may not be able to display, in its immediately allocated space, the entirety of the content associated with that snippet. Consistent with the principles of the present invention, auto-zooming of a snippet may be provided to enable the user to quickly obtain additional information associated with a selected snippet. In some systems, the user may select a snippet or otherwise indicate that a snippet is of interest, for example, by pointing to the snippet with a pointing device such as a mouse. The same indication may also be made, for example, by pointing and clicking on the snippet, by pointing to the snippet and then scrolling, by pressing certain hot keys on a keyboard or by using any other suitable method of bringing attention to a particular snippet. In response, the chosen snippet may be dynamically zoomed to enhance the amount of visible information. For example, when a datasheet snippet is zoomed, additional rows of data, perhaps in larger fonts, may be displayed in the zoomed snippet.

Concurrent with the automatic zooming of one of the snippets on a screen, attributes including size, location, context, etc. of the other snippets on the screen may be adjusted to maintain a reasonable relationship with the zoomed snippet. The extent of zooming may be regulated by the adjustments that are made to the other snippets on the screen. As an example, when a datasheet snippet is zoomed, a graphic snippet that was previously displayed in a side-by-side arrangement with the datasheet snippet may be relocated, for example, to a lower portion of the screen and may be further reduced in size to accommodate and remain in a logical relationship with the zoomed datasheet snippet. At the same time, the visibility and position of the reduced graphic snippet may be taken into consideration during zooming of the datasheet snippet, so that the resulting screen presents both snippets in their adjusted format in a reasonable manner.

In some systems consistent with the principles of the present invention, the screen size may be so limiting and/or the content of the snippets may be so difficult to reduce reasonably, that one or more of the snippets may be temporarily removed from the screen in order to accommodate zooming of one of the snippets. This type of temporary removal decision may be made based upon a number of factors, including the zooming requirements of the zoomed snippet, the reduction limitations of the unzoomed snippets, the relationship among the various snippets, and any other suitable consideration. The removal may be partial or in full. Consistent with the principles of the present invention, a specialized layout manager may be implemented to coordinate the visual presentation of the various snippets in relation to each other.

Further features and embodiments of the present invention will become apparent from the description and the accompanying drawings. It will be understood that the features mentioned above and those described hereinafter may be used not only in the combination specified but also in other combinations or on their own, without departing from the scope of the present invention. It will also be understood that the foregoing background, summary, and the following description of the systems consistent with the principles of the present invention are in no way limiting on the scope of the present invention and are merely illustrations of a preferred embodiment of the present invention.

### BRIEF DESCRIPTION OF THE DRAWINGS

Referring now to the drawings, in which like numerals represent like elements throughout the several FIGures, aspects of the present invention and the exemplary operating environment will be described.

FIG. 1 shows a flow chart of illustrative stages involved in automatic zooming of a snippet in a screen consistent with the principles of the present invention.

FIG. 2 shows a flow chart of illustrative stages involved in arranging a plurality of snippets in a screen consistent with the principles of the present invention.

FIG. 3 shows an exemplary screen having arranged thereon multiple snippets consistent with the principles of the present invention.

FIG. 4 shows exemplary before and after screens in which one of the snippets is zoomed consistent with the principles of the present invention.

FIG. 5 shows an exemplary snippet before and after zooming in a screen consistent with the principles of the present invention.

FIG. 6 is an illustrative computer system for implementing a software application consistent with the principles of the present invention.

FIG. 7 is another illustrative computer system for implementing a software application consistent with the principles of the present invention.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Consistent with the principles of the present invention, multiple displays of information snippets may be simultaneously presented in a graphic user interface/screen. Each display or arrangement of information is referred to as a snippet. In some systems, user interaction may be enabled in connection with the information snippets. In some systems, information snippets containing related information may be suitably arranged to provide a user with a logical display context that illustrates the relationships between the snippets. Consistent with the principles of the present invention, a logical display context may refer to any suitable snippet arrangement that, for example, preserves continuity of display from screen to screen by preserving relative snippet positions on a screen upon zooming of a particular snippet, illustrates a relationship between snippets by allocating adjacent screen spaces to these snippets, or creates any other logical displays of the snippets.

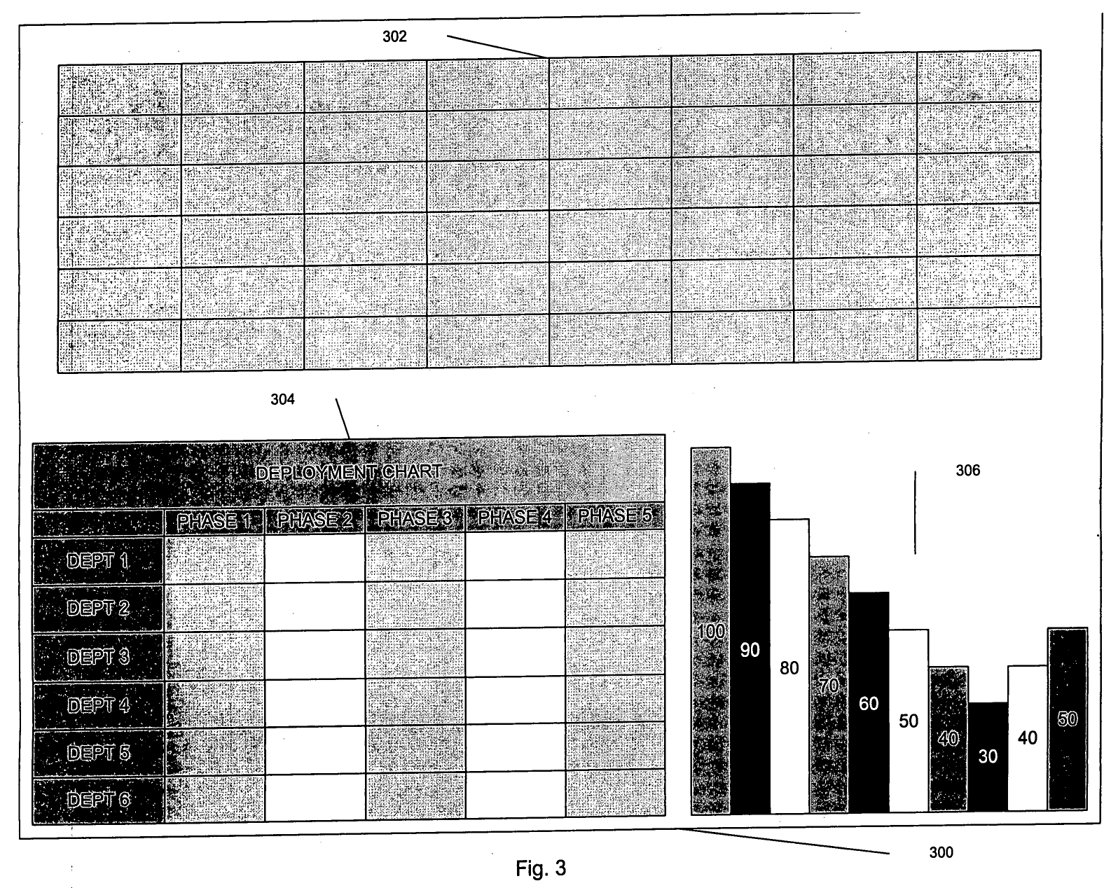

Some exemplary screens containing suitable arrangements of information snippets consistent with the principles of the present invention are shown in FIGS. 3-5. FIG. 3 shows exemplary display screen 300 having displayed thereon three snippets. Display screen 300 may be any computer screen, television screen, or any other suitable display screen. Snippet 302 may contain a datasheet table, in which all or some of the rows and columns that are a part of the datasheet table are displayed in the immediate space allocated to snippet 302 on screen 300. In some systems consistent with the principles of the invention, mechanisms for scrolling or otherwise manipulating the datasheet or any other elements of snippet 302 may be provided. For clarity and simplicity, these mechanisms are not shown in the FIGS, but are within the scope of the present invention.

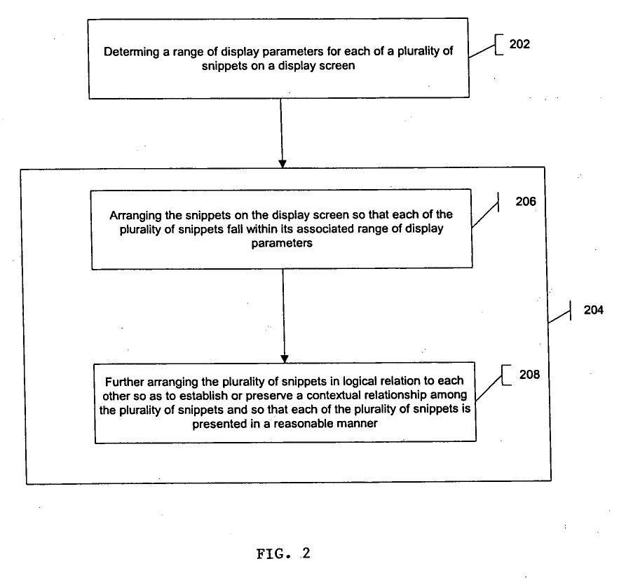

The number of rows and columns that are immediately shown in snippet 302 may be pre-determined, for example, in accordance with processes, which will be explained in connection with FIG. 2 below. The display of information in snippet 302 thus determined may provide an optimum and logical presentation of the datasheet while taking into account various unique factors associated with screen 300, including, for example, display requirements of other snippets that are also displayed on screen 300.

Snippet 304 may contain another datasheet. Similar to snippet 302, the immediate display of the datasheet in snippet 304, including the number of rows and columns immediately shown, may be determined based on a number of factors, such as those described below in connection with the flowchart of FIG. 2. Also included in screen 300 may be snippet 306, in which a bar chart representing the datasheet of snippet 304 is shown. As described above in accordance with the processes of FIG. 2, snippet 306 may be suitably arranged on screen 300 to demonstrate its relatedness to snippet 304. In the current example, snippet 306 is displayed side-by-side with snippet 304. In some systems consistent with the principles of the present invention, the content, such as the bars of the bar chart currently shown in snippet 306, may correspond to the currently shown content of snippet 304. In this way, the side-by-side arrangement establishes a context that demonstrates the logical relationship between the snippets 304 and 306.

It will be understood that display screen 300 is merely illustrative of such a display screen. Any other suitable display screen may be used without departing from the spirit of the present invention.

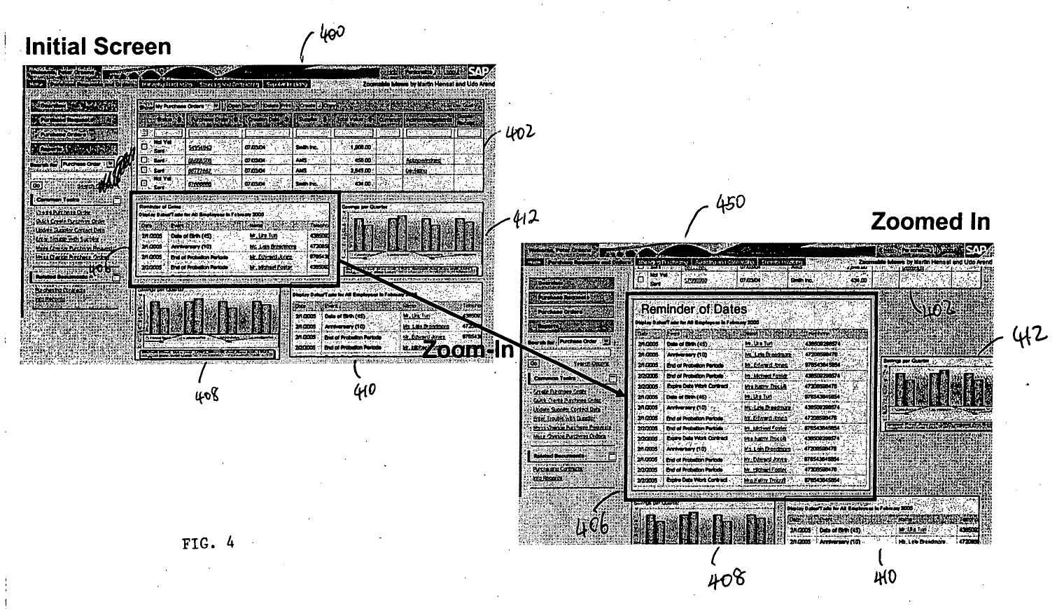

FIG. 4 shows exemplary before and after screens demonstrating zooming of one of the snippets consistent with the principles of the present invention. Initial screen 400 may incorporate similar features as those described above in connection with screen 300 of FIG. 3. In screen 400, snippets 402-412 may be displayed without overlap and in an overall context that reflects logical relationships among the snippets. Each snippet 402-412 may be displayed within its predetermined display parameters, for example, in accordance with the processes of FIG. 2, so as ensure that each snippet's content is presented in a logical and reasonable manner.

In this example, a detection has been made indicating that a user is interested in the content of snippet 406. The user may make such an indication of interest by, for example, pointing to snippet 406 with a pointing device such as a mouse, pointing to snippet 406 and scrolling, clicking on snippet 406, pressing a suitable hot key on a keyboard, or using any other suitable means for indicating interest. In response to user indication of interest in snippet 406, snippet 406 may be automatically zoomed to enhance the amount of information shown.

Screen 450 illustrates one possible layout of snippets 402-412 subsequent to zooming of snippet 406. Snippet 406 may be associated with a full range of display parameters, which may include display parameters that dictate how the snippet is to appear when it is not zoomed and those dictating how it appears when zoomed. The range of display parameters that may be associated with a snippet will be described in more detail in connection with FIG. 2 below. Consistent with the principles of the present invention, the range of display parameters may be provided so that zooming may be achieved in stages, for example, from a simple unzoomed stage to a zoomed stage, or continuously until a maximum zoomed size is reached.

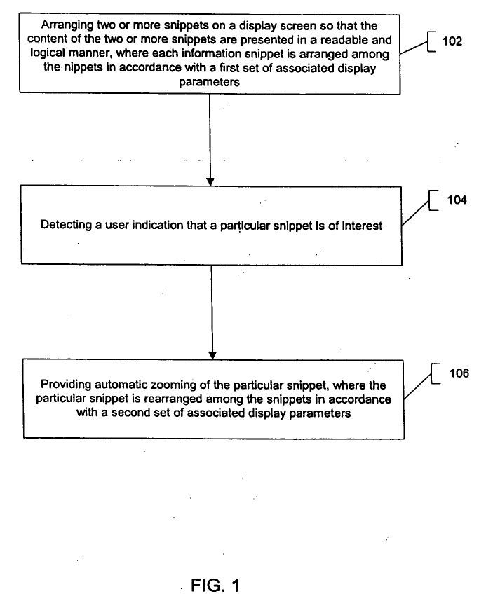

When snippet 406 is zoomed, the amount of content or visual information displayed therein is enhanced. In the present example, snippet 406 contains a table of reminder dates. In the unzoomed snippet 406 of screen 400, elements that provide essential information about the reminder table, including table name, column names, some exemplary rows of data, may be shown to provide logical and reasonable content. The determination of the content and the appropriate arrangement of snippet 406 may be performed in connection with a process, which will be described in more detail in connection with FIG. 1 below. In response to snippet 406 being zoomed in screen 450, snippet 406 may be automatically expanded to include additional data and/or detailed information, which were not previously included in screen 400. In the present example, many additional rows of data are now displayed in zoomed snippet 406. Display parameters, such as fonts and spacing, may also be automatically modified in zoomed snippet 406 to further enhance the visual presentation of the reminder table. The additional data and/or detailed information may be information that have always been associated with snippet 406, but were unable to fit in the previously unzoomed space of snippet 406. In some systems consistent with the principles of the present invention, the user may access such hidden information in the snippets unzoomed state, for example, by using a scrolling or any other suitable mechanism.

Concurrently with zooming of snippet 406, the other snippets on screen 450 may be readjusted to accommodate the zoomed snippet 406. The readjustment may be made to ensure that presentation of content in each snippet remains logical and reasonable. This may mean that the snippets in screen 450 are rearranged so that there are no overlapping snippets or obscured content. This may also mean that the display parameters of various snippets may be adjusted to accommodate the zoomed snippet. This may additionally mean that the snippets may be rearranged so that an existing context, for example, a context which reflects relationships among the snippets, is preserved.

In the present example, snippets 402, 408, 410, and 412 have been rearranged so as not to overlap with zoomed snippet 406. The relative positions of snippets 402, 408, 410, and 412 in screen 450 is substantially preserved from that of screen 400. Due to space limitation, portions of snippets 402, 408, 410, and 412 are removed from screen 450 temporarily. A decision to remove these portions may have been made, for example, by a layout manager, upon determining that snippets 402, 408, 410, and 412 could not be further reduced to fit in screen 450 without obscuring their content.

It will be understood that screens 400 and 450 are merely illustrative of such display screen or graphic user interface. Any other suitable screen may be used without departing from the spirit of the present invention.

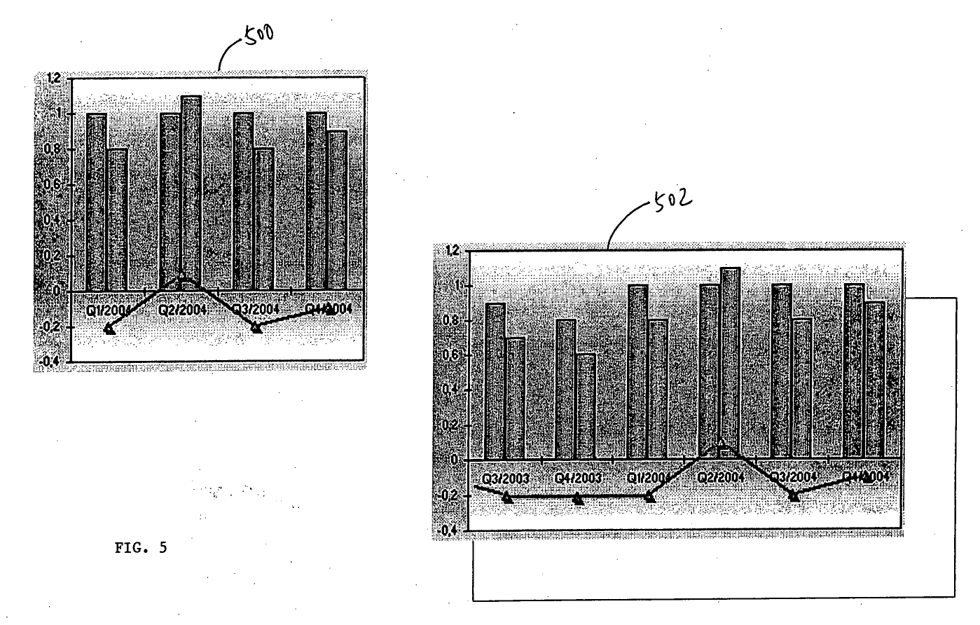

FIG. 5 shows an exemplary snippet before and after zooming in a system consistent with the principles of the present invention. In the present example, unzoomed and zoomed snippets 500 and 502 respectively display bar charts presenting data grouped by quarter. Prior to being zoomed, snippet 500 may display a subset of the bars in its bar chart. The subset displayed may be selected, for example, to present the most recent data, to illustrate a specific trend, or to serve any other suitable purpose. Regardless of how the subset or otherwise reduced content is selected and/or determined, unzoomed snippet 500 may be displayed with a sufficient amount of information so as to convey the essence or overall character of the entire content, for example, to indicate to the user that snippet 500 is a graphic snippet. In order to do so, snippet 500 may be displayed in accordance with suitable display parameters so as to ensure that the essential content associated with the graphic snippet is not obscured, for example, by using a process such as the one, which will be described in connection with FIG. 1 below, to determine the essential content and the suitable snippet arrangement. Exemplary processes for displaying a snippet in accordance with such display parameters are described above in connection with FIG. 2.

Zooming of snippet 500 may result in the display of snippet 502. In snippet 502, the reduced bar chart previously shown in snippet 500 may be expanded or otherwise adjusted to enhance the visual information presented. For example, additional bars and data, which were not previously displayed in snippet 500, may be shown in zoomed snippet 502. Consistent with the principles of the present invention, colors and/or other display details or characteristics, such as fonts, spacing, and/or other suitable details, may be adjusted or added in snippet 502 to further enhance the graphic display. These display details may be selected from or otherwise determined in accordance with display parameters set forth in connection with the snippet, for example, as described in connection with the exemplary processes of FIG. 2 below.

FIG. 1 shows a flow chart of illustrative stages involved in automatic zooming of a snippet consistent with the principles of the present invention. Initially, at stage 102, two or more snippets may be arranged on a display screen in such a way that the content of the two or more snippets are presented to the user in a readable and logical manner. Two or more snippets thus arranged, for example, may be without overlap so that each snippet may be plainly visible to the user. The type of arrangement may also ensure that the font and other layout attributes associated with each of the snippets are adjusted so that the content of the snippet is not obscured and is easily ascertainable by the user. For example, a graphics snippet arranged on a screen in this fashion, regardless of its allocated size, may be guaranteed to at least provide the user with an idea of what the graphics as a whole is trying to show, and not just a cropped corner of a large image.

The logical presentation of the snippets may additionally encompass arranging related snippets according to the relationships between them. As an example, four snippets may appear in a screen, in which two snippets contain related content. Specifically, one of the related snippets may include a table that associates employee names with their corresponding employee numbers and the other related snippet may include a table that associates the employee numbers with the employees' salaries. When presenting the four snippets on the screen in accordance with stage 102, the two related snippets may be placed side-by-side, so as to make it easy for the user to identify an employee name and that employee's corresponding salary using the two snippets.

At stage 104, a user indication, signalling that a particular snippet on a display screen is of interest, may be detected. The user indication may take various suitable forms. As an example, the user may point to a snippet on the screen, for example, by placing a mouse pointer over the snippet (mouse-over) or by using any other suitable pointing means. As another example, the user may point and click on a particular snippet. As another example, the user may point to a snippet and then scroll to elicit additional information. As yet another example, the user may utilize, for example, designated hot keys on a keyboard to select a particular snippet. The above examples for indicating user interest in a snippet is merely illustrative, any other suitable mechanism and/or method may be used without departing from the spirit of the present invention.

Once user interest in a particular snippet is detected, the system consistent with the principles of the present invention may automatically zoom to that particular snippet, for example, by expanding that snippet display, to present the user with a more complete and detailed view. For example, the snippet may be resized to occupy a larger screen space, in which some of the previously hidden and/or abbreviated information may now be displayed. Also, the font, color, and other suitable layout attribute may be adjusted in the zoomed snippet so as to enhance the more detailed presentation of the information therein. As an example, in a zoomed snippet, a previously black and white summary bar chart may be replaced by a multi-colored bar chart having additional bars to represent a more complete dataset.

Concurrent with the zooming of one of the snippets at stage 106, the other snippets in the same screen may be rearranged and/or otherwise adjusted so as to preserve any contextual relationship that had previously existed among the snippets. In one example, each of the snippets that are not zoomed may remain in its relative location on the screen, but may be resized to make room for the zoomed snippet. In this way, the overall context that had previously existed among the snippets prior to the zooming may be preserved. Resizing of the unzoomed snippets may be performed in a reasonable fashion so to ensure that content of these snippets will not become obscured.

In some instances, the number of snippets in a screen and/or the content of one or more snippets are such that reduction of one or more snippets, as described above, cannot be performed without obscuring the content and/or destroying the contextual layout of at least some of the snippets. In such situations, snippets that are not closely related to the zoomed snippet may be, for example, sent, fully or partially, to a background layer or moved off the screen temporarily. This allows those snippets that are most related to the content of the zoomed snippet to remain on the screen and be presented to the user in a context that is closest to the layout context that had existed among the snippets prior to the zooming. A more detailed description of the adjustments that may be made to a snippet when zoomed or reduced may be found in connection with the discussion of FIG. 2 below.

In recognition of the process associated with arranging and rearranging the snippets on a screen so that each snippet may be presented in a reasonable and logical manner, a specialized layout manager may be implemented to coordinate the process consistent with the principles of the present invention. FIG. 2 shows a flow chart of stages involved in adjusting and arranging snippets.

At stage 202, a range of display parameters may be determined for each of a plurality of snippets on a display screen. The display parameters may include, for example, maximum and minimum font sizes, maximum and minimum snippet sizes, maximum and minimum zoom resolutions, maximum and minimum row and column numbers of various tables, resizing parameters for graphics, and any other suitable display parameters that may be associated with a snippet. The display parameters of a snippet may be dynamically determined based on, for example, the display screen in which the snippet is to be displayed, the computer system on which the snippet is to be implemented, the other snippets that the snippet is to be displayed with, and/or any other suitable factor. The display parameters may be predetermined, determined dynamically, or determined in any other suitable fashion.

At stage 204, a plurality of snippets may be logically arranged on a display screen based on the set of display parameters determined at stage 202. Consistent with the principles of the present invention, stage 204 may include two or more sub-stages 206 and 208. Sub-stages 206 and 208 may be performed sequentially, concurrently, or in any other suitable manner. At stage 206, each of the snippets may be placed on the display screen so that it falls within its associated range of display parameters. As an example, it may be made certain, at stage 206, that the size of a snippet is within its maximum and minimum allowed sizes as indicated by its associated display parameters. As another example, display characteristics of the content in a snippet, including font, graphic size, and other suitable display characteristic, may be regulated by the associated display parameters. Consistent with the principles of the present invention, when zooming or reducing a snippet, precautions may be taken, for example, to ensure that the zoomed or reduced snippet remains within the bounds of its associated display parameters.

Complementary to the display arrangement of individual snippets at stage 206, the overall arrangement of snippets on a display screen may be contemplated at stage 208. Snippets may be arranged in relation to each other based on a number of factors in an attempt to create a logical and coherent presentation. The factors considered may include, for example, relatedness of snippet content, sizes of snippets, which may include zoomed or reduced sizes, previous existing layout context among snippets, and/or any other suitable factor. As an example, at stage 208, two snippets containing related content, such as a datasheet and a chart representing the datasheet, may be placed in close proximity to each other on the screen. When zooming to the datasheet, the corresponding chart may be reduced, but the existing context or visual relationship between the two snippets may be maintained. For example, the reduced chart snippet may retain its relative position on the screen in relation to the datasheet snippet. In circumstances where additional unrelated snippets are also displayed on the screen, the relative positions of those snippets, when reduced may be substantially preserved. However, because those snippets are not highly relevant to the zoomed graphic, if screen space becomes limited during zooming, some or all of those unrelated snippets may be, for example, partially covered, moved to a different location, or completely but temporarily removed from the screen.

It will be understood that stages 206 and 208 are merely illustrative of adjustment processes for achieving a logical presentation of snippets in a screen. Stages 206 and 208 may take place sequentially, concurrently, or in any other suitable order, and any other suitable process may be used without departing from the spirit of the present invention.

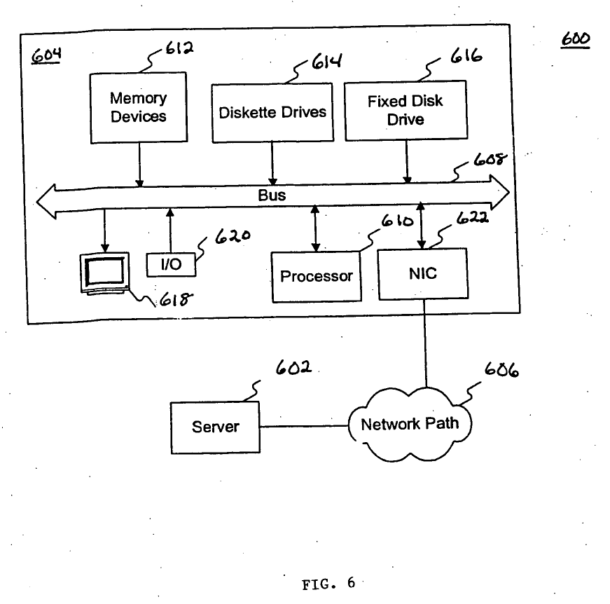

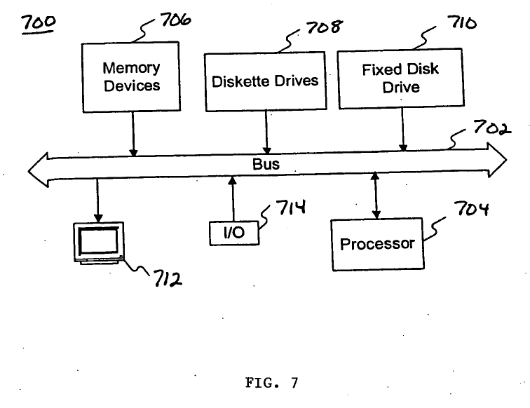

A computer system may be used to install a software application implementing a system and method for providing automatic zooming of a snippet in a screen consistent with the principles of the present invention. The computer system may be a computer network, as shown in FIG. 6, or a stand-alone personal computer (PC), as shown in FIG. 7.

As shown in FIG. 6, a computer network 600 in accordance with systems consistent with the principles of the present invention may include a server 602 and a stand-alone PC 604 connected through a network path 606. Computer network 600 may be a local area network (LAN), where server 602 and PC 604 are workstations. Computer network 600 may also be the Internet, with server 602 hosting a web application and PC 604 being any workstation available to a user desiring to interface with the application on server 602. Alternatively, computer network 600 may be a wide area network (WAN), and server 602 and PC 604 may lie in two separate LANs connected through the Internet.

PC 604 may include a bus line 608 connecting a plurality of devices such as a processor 610, memory devices 612 for storage of information, diskette drives 614, a fixed disk drive 616, a monitor or display 618, other I/O devices 620, and a network interface card (NIC) 622. Processor 610 may be a microprocessor such as an Intel Pentium™ chip for processing applications. Memory devices 612 may include read-only memories (ROM) and/or random access memories (RAM). Diskette drives 614 may include a floppy drive and/or a compact disk (CD) drive. Fixed disk drive 616 may be a hard drive. I/O devices 620 may include a keyboard and/or a mouse for receiving input from a user of PC 604. Monitor or display 618 may display output from processor 610, and may also echo the input of the user. PC 604 may be connected to network path 606 through NIC 622.

A web application may be installed on server 602. An individual desiring to enter data into the application on server 602 may use a web browser loaded on PC 604, and may communicate with server 602 through NIC 622 and network path 606. In one aspect, software application for implementing a system consistent with the principles of the present invention may be stored in PC 604 and processor 610 of PC 604 may execute the software application locally within PC 604 and interface with a web application on server 602. Particularly, the software application may be stored on a floppy disk, a CD, or any other suitable readable media, which may be accessible by diskette drive 614, fixed disk drive 616, or any other suitable mechanism. In another aspect, the software application for implementing a system consistent with the principles of the present invention may be stored in server 602, which may execute the software application, and processor 610 of PC 604 may communicate with server 602 to send information to server 602 and retrieve the results of the execution of the software application from server 602.

Through the execution of the software application implementing a system consistent with the principles of the present invention, either locally within PC 604 or remotely within server 602, an interface or screen may be provided on a user display, which enables the display of snippets.

Alternatively, as shown in FIG. 7, a stand-alone PC 700 may be used for implementing a software application implementing a system consistent with the principles of the present invention. PC 700 may include a bus line 702 connecting a plurality of devices, which may include a processor 704, memory devices 706 for storage of information, diskette drives 708, a fixed disk drive 710, a monitor or display 712, and other I/O devices 714. Processor 704 may be a microprocessor such as an Intel Pentium™ chip for processing applications. Memory devices 706 may include ROM and/or RAM. Diskette drives 708 may include a floppy drive and/or a compact disk (CD) drive. Fixed disk drive 710 may be a hard drive. Monitor or display 712 may display the output of processor 704 and may also echo the input of the user. I/O devices 714 may include a keyboard and/or a mouse for receiving input from a user of PC 700.

A software application implementing a system consistent with the principles of the present invention may be stored on a floppy disk or a CD accessible by diskette drive 708 or on fixed disk drive 710. Processor 704 may execute the software application stored in the floppy disk the CD or the fixed disk drive 710. An individual, through monitor or display 712 and I/O devices 714, may interact with processor 704, which may execute the software application. A software application implementing a system consistent with the principles of the present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for simultaneously presenting multiple information snippets in a graphic user interface, the method comprising:
arranging the multiple information snippets in the graphic user interface, wherein each information snippet is arranged among the multiple information snippets in accordance with a first set of associated display parameters;
detecting a user indication of interest in a first one of the multiple information snippets; and
providing automatic zooming of the first one of the multiple information snippets in the graphic user interface.

2. The method of claim 1, wherein providing automatic zooming comprises arranging the first one of the multiple information snippets among the multiple information snippets in accordance with a second set of associated display parameters.

3. The method of claim 2, further comprising arranging other of the multiple information snippets in accordance with a second set of display parameters associated with each of the other multiple information snippets in response to automatic zooming of the first one of the multiple information snippets.

4. The method of claim 1, wherein the associated display parameters are selected from a predetermined range of suitable display parameters.

5. The method of claim 2, wherein arranging the first one of the multiple information snippets among the multiple information snippets in accordance with a second set of associated display parameters comprises adjusting display parameters associated with the first one of the multiple information snippets to provide more detailed content.

6. The method of claim 1, wherein the associated display parameters includes size, location, and context.

7. A system for simultaneously presenting multiple information snippets in a graphic user interface, the system comprising:
an I/O device;
a display; and
a processor configured to:
arrange the multiple information snippets in the graphic user interface on the display, wherein each information snippet is arranged among the multiple information snippets in accordance with a first set of associated display parameters;
detect a user indication of interest, from the I/O device, in a first one of the multiple information snippets; and
provide automatic zooming of the first one of the multiple information snippets in the graphic user interface on the display.

8. The system of claim 7, wherein the processor is further configured to arrange the first one of the multiple information snippets among the multiple information snippets in accordance with a second set of associated display parameters.

9. The system of claim 8, wherein the processor is further configured to arrange other of the multiple information snippets in accordance with a second set of display parameters associated with each of the other multiple information snippets in response to automatic zooming of the first one of the multiple information snippets.

10. The system of claim 7, wherein the associated display parameters are selected from a predetermined range of suitable display parameters.

11. The system of claim 8, wherein the processor is further configured to adjust display parameters associated with the first one of the multiple information snippets to provide more detailed content.

12. The system of claim 7, wherein the associated display parameters includes size, location, and context.

13. A computer-readable medium including instructions for performing, when executed by a processor, a method comprising:
arranging the multiple information snippets in the graphic user interface, wherein each information snippet is arranged among the multiple information snippets in accordance with a first set of associated display parameters;
detecting a user indication of interest in a first one of the multiple information snippets; and
providing automatic zooming of the first one of the multiple information snippets in the graphic user interface.

14. The computer-readable medium of claim 13 further includes instructions for arranging the first one of the multiple information snippets among the multiple information snippets in accordance with a second set of associated display parameters.

15. The computer-readable medium of claim 14 further includes instructions for arranging other of the multiple information snippets in accordance with a second set of display parameters associated with each of the other multiple information snippets in response to automatic zooming of the first one of the multiple information snippets.

16. The computer-readable medium of claim 13, wherein the associated display parameters are selected from a predetermined range of suitable display parameters.

17. The computer-readable medium of claim 14 further includes instructions for adjusting display parameters associated with the first one of the multiple information snippets to provide more detailed content.

18. The computer-readable medium of claim 13, wherein the associated display parameters includes size, location, and context.
